(19) United States
(12) Patent Application Publication
(10) Pub. No.: US 2019/0333015 A1
(43) Pub. Date: Oct. 31, 2019

(54) RISK MANAGEMENT SYSTEM FOR PERISHABLE GOOD TRANSPORT

(71) Applicant: CARRIER CORPORATION, Jupiter, FL (US)

(72) Inventors: Marc Beasley, Beverly, MA (US); Ciara Poolman, Syracuse, NY (US); Robert A. Chopko, Baldwinsville, NY (US); John Cronin, Bonita Springs, FL (US); Seth Melvin Cronin, Essex Junction, VT (US); Jonathan T. Goguen, Brookline, NH (US); Michael Glynn D'Andrea, Burlington, VT (US)

(21) Appl. No.: 16/319,407

(22) PCT Filed: Jul. 20, 2017
(86) PCT No.: PCT/US2017/043055

§ 371 Date: Jan. 21, 2019

Related U.S. Application Data
(60) Provisional application No. 62/365,723, filed on Jul. 22, 2016.

(51) Int. Cl. G06Q 10/08; G06Q 10/06

(52) U.S. Cl. CPC G06Q 10/0832; G06Q 10/063116; G06Q 10/0635

(57) ABSTRACT

A system for managing risk associated with the transportation of perishable goods including a storage device to store perishable good requirements, sanitation schedule parameters, sanitation requirements, maintenance schedule parameters, maintenance requirements, transportation schedules, and transport parameters associated with the perishable goods; and a risk management system coupled to the storage device. The risk management system including: a risk assessment module to determine: quality risk levels, sanitation risk levels, and maintenance risk levels in response to at least one of transport parameters, perishable good requirements, transportation schedules; sanitation schedule parameters, sanitation requirements, maintenance schedule parameters, and maintenance requirements; a schedule module to determine schedule adjustments in response to at least one of the quality risk level, sanitation risk level, and maintenance risk level; and a meshing module to determine instructions in response to at least one of the quality risk level, sanitation risk level, maintenance risk level, and schedule adjustments.

### BACKGROUND OF THE DISCLOSURE

The embodiments disclosed herein generally relate to cold chain distribution systems, and more specifically to an apparatus and a method for managing risk for perishable goods.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

Consumers are becoming increasingly concerned with the quality of the perishable goods they are purchasing and many factors must be controlled when attempting to maintain a high quality perishable good. It is often difficult analyze the risk levels facing perishable goods during transporting to the consumer as the perishable goods may change hands several times along the route. Improved systems, particularly improved systems for monitoring risk and adjusting for that risk would provide benefits to the industry.

### BRIEF DESCRIPTION OF THE DISCLOSURE

According to one embodiment, a system for managing risk associated with the transportation of perishable goods is provided. The system includes: a storage device to store perishable good requirements, sanitation schedule parameters, sanitation requirements, maintenance schedule parameters, maintenance requirements, transportation schedules, and transport parameters associated with the perishable goods; and a risk management system coupled to the storage device. The risk management system including: a risk assessment module to determine: quality risk levels in response to at least one of the transport parameters, the perishable good requirements, and the transportation schedules; sanitation risk levels in response to at least one of the transport parameters, the perishable good requirements, the sanitation schedule parameters, and the sanitation requirements; and maintenance risk levels in response to at least one of the transport parameters, the perishable good requirements, the maintenance schedule parameters, and the maintenance requirements; a schedule module to determine schedule adjustments in response to at least one of the quality risk level, the sanitation risk level, and the maintenance risk level; and a meshing module to determine instructions in response to at least one of the quality risk level, the sanitation risk level, the maintenance risk level, and the schedule adjustments.

In addition to one or more of the features described above, or as an alternative, further embodiments of the system may include that the meshing module is configured to transmit the instructions to a user device.

In addition to one or more of the features described above, or as an alternative, further embodiments of the system may include that the storage device is configured to receive user input from a user device.

In addition to one or more of the features described above, or as an alternative, further embodiments of the system may include that the schedule module transmits schedule adjustments to the storage device; and the storage device updates at least one of the sanitation schedule parameters, the maintenance schedule parameters, and the transportation schedules.

In addition to one or more of the features described above, or as an alternative, further embodiments of the system may include that the risk assessment module transmits at least one of the quality risk levels, sanitation risk levels, and the maintenance risk levels to the storage device; and the storage device updates at least one of the perishable good requirements, the sanitation requirements, and the maintenance requirements.

In addition to one or more of the features described above, or as an alternative, further embodiments of the system may include at least one sensor configured to monitor the transport parameters of the perishable goods and transmit the transport parameters to the storage device.

In addition to one or more of the features described above, or as an alternative, further embodiments of the system may include a user device that activates an alarm when the quality risk level is greater than or equal to a selected quality risk level.

In addition to one or more of the features described above, or as an alternative, further embodiments of the system may include a user device that activates an alarm when the sanitation risk level is greater than or equal to a selected sanitation risk level.

In addition to one or more of the features described above, or as an alternative, further embodiments of the system may include a user device that activates an alarm when the maintenance risk level is greater than or equal to a selected maintenance risk level.

According to another embodiment, a method of managing risk associated with the transportation of perishable goods is provided. The method includes: storing, using a storage device, perishable good requirements, sanitation schedule parameters, sanitation requirements, maintenance schedule parameters, maintenance requirements, transportation schedules, and transport parameters associated with the perishable goods; and analyzing, using a risk management system, the perishable good requirements, the sanitation schedule parameters, the sanitation requirements, the maintenance schedule parameters, the maintenance requirements, the transportation schedules, and the transport parameters. The risk management system coupled to the storage device. The risk management system including: a risk management system coupled to the storage device, the risk management system including: a risk assessment module to determine: quality risk levels in response to at least one of the transport parameters, the perishable good requirements, and the transportation schedules; sanitation risk levels in response to at least one of the transport parameters, the perishable good requirements, the sanitation schedule parameters, and the sanitation requirements; and maintenance risk levels in response to at least one of the transport parameters, the perishable good requirements, the maintenance schedule parameters, and the maintenance requirements; a schedule module to determine schedule adjustments in response to at least one of the quality risk level, the sanitation risk level, and the maintenance risk level; and a meshing module to determine instructions in response to at least one of the quality risk level, the sanitation risk level, the maintenance risk level, and the schedule adjustments.

In addition to one or more of the features described above, or as an alternative, further embodiments of the method may include transmitting, using the meshing module, instructions to a user device.

In addition to one or more of the features described above, or as an alternative, further embodiments of the method may include receiving, using the storage device, user inputs from a user device.

In addition to one or more of the features described above, or as an alternative, further embodiments of the method may include transmitting, using the schedule module, schedule adjustments to the storage device; and updating, using the storage device, at least one of the sanitation schedule parameters, the maintenance schedule parameters, and the transportation schedules.

In addition to one or more of the features described above, or as an alternative, further embodiments of the method may include transmitting, using the risk assessment module, at least one of the quality risk levels, sanitation risk levels, and the maintenance risk levels to the storage device; and updating, using the storage device, at least one of the perishable good requirements, the sanitation requirements, and the maintenance requirements.

In addition to one or more of the features described above, or as an alternative, further embodiments of the method may include monitoring, using at least one sensor, the transport parameters of the perishable goods; and transmitting the transport parameters to the storage device.

In addition to one or more of the features described above, or as an alternative, further embodiments of the method may include activating, using a user device, an alarm when the quality risk level is greater than or equal to a selected quality risk level.

In addition to one or more of the features described above, or as an alternative, further embodiments of the method may include activating, using a user device, an alarm when the sanitation risk level is greater than or equal to a selected sanitation risk level.

In addition to one or more of the features described above, or as an alternative, further embodiments of the method may include activating, using a user device, an alarm when the maintenance risk level is greater than or equal to a selected maintenance risk level.

According to another embodiment, a computer program product tangibly embodied on a computer readable medium is provided. The computer program product including instructions that, when executed by a processor, cause the processor to perform operations. The operations include: storing, using a storage device, perishable good requirements, sanitation schedule parameters, sanitation requirements, maintenance schedule parameters, maintenance requirements, transportation schedules, and transport parameters associated with the perishable goods; and analyzing, using a risk management system, the perishable good requirements, the sanitation schedule parameters, the sanitation requirements, the maintenance schedule parameters, the maintenance requirements, the transportation schedules, and the transport parameters, the risk management system coupled to the storage device, the risk management system including: a risk management system coupled to the storage device, the risk management system including: a risk assessment module to determine: quality risk levels in response to at least one of the transport parameters, the perishable good requirements, and the transportation schedules; sanitation risk levels in response to at least one of the transport parameters, the perishable good requirements, the sanitation schedule parameters, and the sanitation requirements; and maintenance risk levels in response to at least one of the transport parameters, the perishable good requirements, the maintenance schedule parameters, and the maintenance requirements; a schedule module to determine schedule adjustments in response to at least one of the quality risk level, the sanitation risk level, and the maintenance risk level; and a meshing module to determine instructions in response to at least one of the quality risk level, the sanitation risk level, the maintenance risk level, and the schedule adjustments.

In addition to one or more of the features described above, or as an alternative, further embodiments of the computer program may include that the operations further include: transmitting, using the meshing module, instructions to a user device.

In addition to one or more of the features described above, or as an alternative, further embodiments of the computer program may include that the operations further include receiving, using the storage device, user inputs from a user device.

In addition to one or more of the features described above, or as an alternative, further embodiments of the computer program may include that the operations further include: transmitting, using the schedule module, schedule adjustments to the storage device; and updating, using the storage device, at least one of the sanitation schedule parameters, the maintenance schedule parameters, and the transportation schedules.

In addition to one or more of the features described above, or as an alternative, further embodiments of the computer program may include that the operations further include: transmitting, using the risk assessment module, at least one of the quality risk levels, sanitation risk levels, and the maintenance risk levels to the storage device; and updating, using the storage device, at least one of the perishable good requirements, the sanitation requirements, and the maintenance requirements.

In addition to one or more of the features described above, or as an alternative, further embodiments of the computer program may include that the operations further include: monitoring, using at least one sensor, the transport parameters of the perishable goods; and transmitting the transport parameters to the storage device.

In addition to one or more of the features described above, or as an alternative, further embodiments of the computer program may include that the operations further include activating, using a user device, an alarm when the quality risk level is greater than or equal to a selected quality risk level.

In addition to one or more of the features described above, or as an alternative, further embodiments of the computer program may include that the operations further include activating, using a user device, an alarm when the sanitation risk level is greater than or equal to a selected sanitation risk level.

In addition to one or more of the features described above, or as an alternative, further embodiments of the computer program may include that the operations further include activating, using a user device, an alarm when the maintenance risk level is greater than or equal to a selected maintenance risk level.

Technical effects of embodiments of the present disclosure include tracking various parameters of perishable goods, using the parameters to determine the risk levels and commanding actions to mitigate risks level of a transport container.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for managing risk associated with the transportation of perishable goods, according to an embodiment of the present disclosure;

FIG. 2 illustrates a schematic view of a cold chain distribution system that may incorporate embodiments of the present disclosure; and

FIG. 3 is a flow diagram illustrating a method for managing risk associated with the transportation of perishable goods, according to an embodiment of the present disclosure.

### DETAILED DESCRIPTION OF THE DISCLOSURE

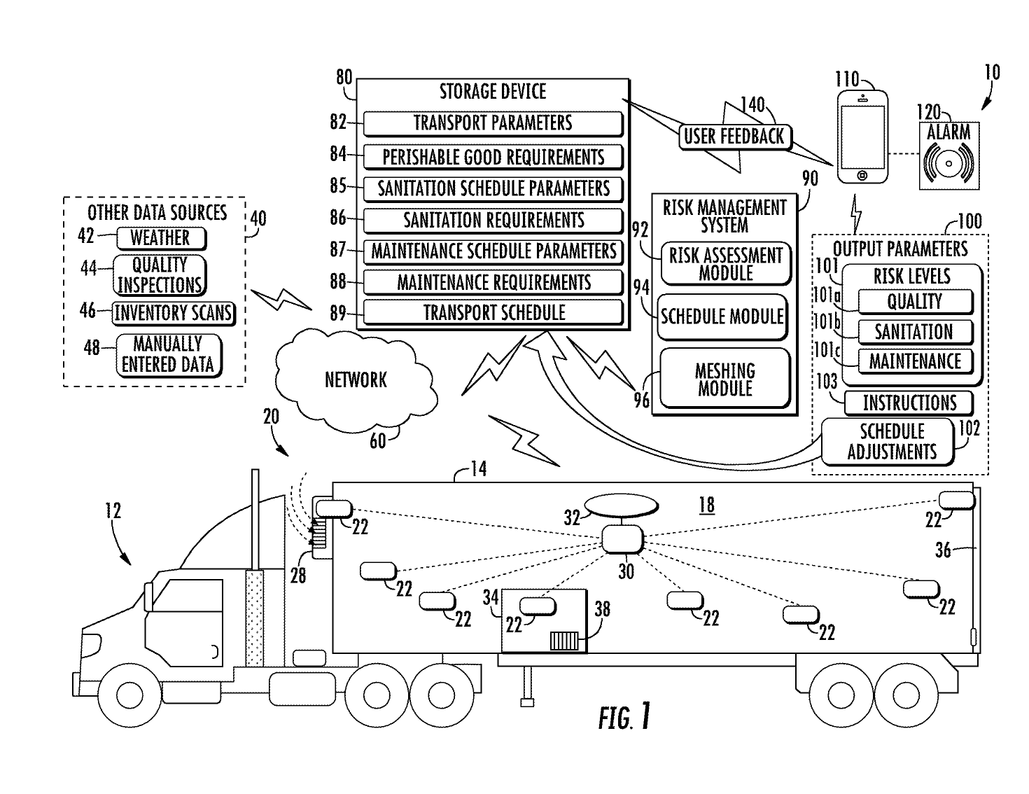

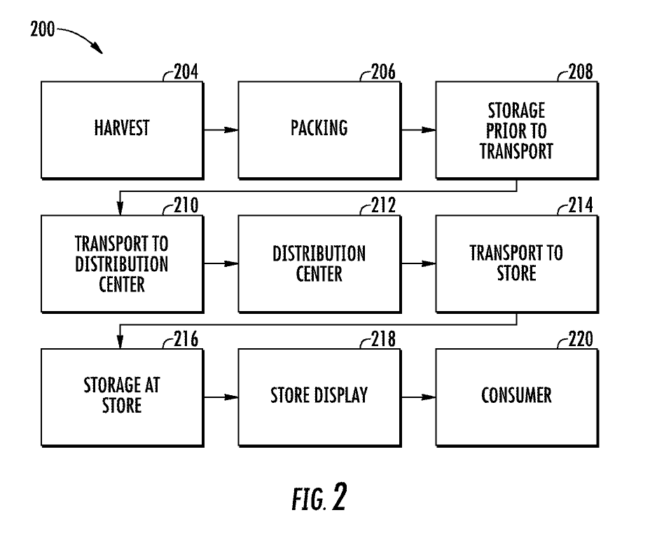

Referring now to the drawings, FIG. 1 illustrates a schematic view of a system 10 for managing risk associated with the transportation of perishable goods 34, according to an embodiment of the present disclosure. FIG. 2 illustrates a schematic view of a cold chain distribution system 200 that may incorporate embodiments of the present disclosure. Typically, transport refrigeration systems 20 are used to transport and distribute perishable goods and environmentally sensitive goods (herein referred to as perishable goods 34). In the illustrated embodiment, a transport refrigeration system 20 includes the environmentally controlled container 14, a transport refrigeration unit 28 and perishable goods 34. The container 14 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the transport refrigeration unit 28 is associated with a container 14 to provide desired environmental parameters, such as, for example, temperature, pressure, humidity, carbon dioxide, ethylene, ozone, light exposure, vibration exposure, and other conditions to the interior compartment 18. In an embodiment, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22, which may be hard wired or wireless. The sensors 22 may be utilized to monitor transport parameters 82 of the perishable goods 34. The transport parameters 82 monitored by the sensors 22 may include but are not limited to temperature, pressure, humidity, carbon dioxide, ethylene, ozone, light exposure, vibrations, and other conditions in the interior compartment 18. Accordingly, suitable sensors 22 are utilized to monitor the desired transport parameters 82. Advantageously, sensors 22 may be selected for certain applications depending on the type of perishable goods 34 to be monitored and the corresponding environmental sensitivities. For instance, perishable goods 34 that are hyper sensitive to carbon dioxide may require additional sensors 22 specifically for carbon dioxide. In an embodiment, temperatures are monitored. As seen in FIG. 1, the sensors 22 may be placed directly on the perishable goods 34.

Additionally, the sensors 22 may be placed in a variety of locations including but not limited to on the transport refrigeration unit 28, on a door 36 of the container 14 and throughout the interior compartment 18. The sensors 22 may be placed directly within the transport refrigeration unit 28 to monitor the performance of the transport refrigeration unit 28. As seen, the sensors 22 may also be placed on the door 36 of the container 14 to monitor the position of the door 36. Whether the door 36 is open or closed affects both the temperature of the container 14 and the perishable goods 34. For instance, in hot weather, an open door 36 will allow cooled air to escape from the container 14, causing the temperature of the interior compartment 18 to rise, thus affecting the temperature of the perishable goods 34 and potentially decreasing the quality level of the perishable goods and increasing the risk of spoilage. Spoilage of perishable goods may require additional sanitation of container 14 due to access odor, fluid discharge, or potential bacterial growth. An open door 36 may also create additional stress on the transport refrigeration unit 28 by forcing the transport refrigeration unit 28 to work harder to cool the interior compartment 18.

Additionally, a global positioning system (GPS) location may also be detected by the sensors 22. The GPS location may help in providing time-based location information for the perishable goods 34 that will help in tracking the travel route and other transport parameters 82 along that route. For instance, the GPS location may also help in providing information from other data sources 40 regarding weather 42 experienced by the container 14 along the travel route. The local weather 42 affects the temperature of the container 14 and thus may affect the temperature of the perishable goods 34. The local weather 42 may also affect the operation of the transport refrigeration unit 28. For instance, the transport refrigeration unit 28 may have to work harder on a container 14 travelling through a desert that is exposed to long period of heat and solar gain.

As illustrated in FIG. 1, the transport refrigeration system 20 may further include, a controller 30 configured to log a plurality of readings from the sensors 22, known as the transport parameters 82, at a selected sampling rate. The controller 30 may be enclosed within the transport refrigeration unit 28 or separate from the transport refrigeration unit 28 as illustrated. The transport parameters 82 may further be augmented with time, location stamps or other relevant information. The controller 30 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 20 may include a communication module 32 in operative communication with the controller 30 and in wireless operative communication with a network 60. The communication module 32 is configured to transmit the transport parameters 82 to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface. The short range interface includes at least one of: a wired interface, an optical interface, and a short range wireless interface.

Transport parameters 82 may also be provided by other data sources 40, as illustrated in FIG. 1. These other data sources 40 may be collected at any point throughout the cold chain distribution system 200, which as illustrated in FIG. 2 may include harvest 204, packing 206, storage prior to transport 208, transport to distribution center 210, distribution center 212, transport to store 214, storage at store 216, store display 218 and consumer 220. The perishable goods 34 may be carried in the container 14 during the transport to distribution center 210 and the transport to store 214. These stages are provided for illustrative purposes and a distribution chain may include fewer stages or additional stages, such as, for example, a cleaning stage, a processing stage, and additional transportation stages. The other data sources 40 may include, but are not limited to, weather 42, quality inspections 44, inventory scans 46, and manually entered data 48. The weather 42, as discussed above, has an effect on the operation of the transport refrigeration unit 28 by influencing the temperature of the container 14 during transport (e.g., 210 and 214) but the weather 42 also has other influences on the transport refrigeration unit 28. For instance, the weather 42 prior to and at harvest 204 may have an impact on the quality of the perishable goods 34. Moreover, quality inspections 44, similar to the weather 42, may reveal data of the perishable goods 34 that affects quality and potential for spoilage during transport. For instance, a particular batch of strawberries may have been subjected to rainfall just prior to harvest 204, making them prone to spoilage while in the container 14. Quality inspections 44 may be done by a machine or a human being. Quality inspections 44 performed by a machine may be accomplished using a variety of techniques including but not limited to optical, odor, soundwave, infrared, or physical probe.

Further, inventory scans 46 may also reveal transport parameters 82 about the perishable goods 34 and may help in tracking the perishable goods 34. For instance, the inventory scan 46 may reveal the time, day, truck the perishable goods arrived on, which may help identify the farm if previously unknown. Knowing the origin of the perishable goods 34 may help in tracking potential contamination issues that may arise at a particular farm or production plant. For instance, if one farm experiences a listeria outbreak in a spinach crop, it would be important to identify the container 14 carrying that particular spinach and sanitize the container 14 as soon as possible. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device known to one of skill in the art.

Transport parameters 82 collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Transport parameters 82 may further include attributes of the perishable goods 34 such as, for example, temperature, weight, size, sugar content, maturity, grade, ripeness, labeling, packaging and the type of perishable good. For instance, strawberries may be packaged in 1 pound clamshells, be a certain weight or grade, be organic, and have certain packaging or labels on the clamshells. Packaging may offer some addition protection against contamination while the perishable good 34 is being transported in the container 14.

Transport parameters 82 may include information regarding the type of perishable good, which may help prevent contamination issues between incompatible perishable goods 34 in the same container 14. The type of perishable good 34 may be identified by a manifest or contents list as manually entered data 48. The type of perishable good 34 may also be identified by inventory scans 46, or scans of ID tags 38. The ID tag 38 may be a Universal Product Code (UPC) bar code, Quick Response (QR) code, Radio-frequency identification (RFID) or another identification methodology known to one of skill in the art. Transport parameters 82 may also include information regarding the operation of the environmental control unit 28, as discussed above. The transport parameters 82 may further be augmented with time, location stamps or other relevant information.

In the illustrated embodiment, the system 10 further includes a storage device 80 to store the transport parameters 82 associated with the perishable goods 34. At least one of the transport parameters 82 may be received from a transport refrigeration system 20. The storage device 80 is connected to the communication module 32 through the network 60. As shown, the storage device 80 also stores consumer parameters 89. The storage device 80 may be but is not limited to a random access memory (RAM), read only memory (ROM), or other electronic, optical, magnetic or any other computer readable medium. The storage device may also store perishable good requirements 84, sanitation schedule parameters 85, maintenance schedule parameters 87, maintenance requirements 88, and transportation schedules 89, as discussed below. The transportation schedule 89 is the route that the perishable goods plan to take from harvest 204 to consumer 220. The transportation schedules 89 may be adjusted through schedule adjustments 102 while the perishable goods 34 are in route for a variety of reasons, as discussed further below.

In the illustrated embodiment, the system 10 further includes a risk management system 90. The risk management system 90 is connected to the communication module 32 through the network 60. The risk management system 90 is also coupled to the storage device 80. As shown, the risk management system 90 includes a risk assessment module 92, a schedule module 94, and a meshing module 96. The risk management system 90 may also include a processor (not shown) and an associated memory (not shown). The associated memory may be the storage device 80. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium. The risk assessment module 92, the schedule module 94, and the meshing module 96 may be implemented in software as applications executed by the processor of risk management system 90.

The risk assessment module 92 determines quality risk levels 101a in response to at least one of the transport parameters 82, the perishable good requirements 84, and the transport schedule 89. The risk assessment module 92 also determines sanitation risk levels 101b in response to at least one of the transport parameters 82, the perishable good requirements 84, sanitation schedule parameters 85, and sanitation requirements 86. The risk assessment module 92 also determines maintenance risk levels 101c in response to at least one of the transport parameters 82, the perishable good requirements 84, the maintenance schedule parameters 87, and maintenance requirements 88. Risk levels may be sent back to the storage device 80 to update at least one of the perishable good requirements 84, the sanitation requirements 86, and the maintenance requirements 88. The updates may occur through machine learning techniques to fine tune the requirements 84, 86, 88 to specific perishable goods 34 to ensure the highest quality.

The schedule module 94 determines schedule adjustments 102 in response to at least one of the quality risk level 101a, sanitation risk levels 101b, and the maintenance risk levels 101c. The schedule adjustments 102 may be sent back to the storage device 80 to update at least one of the sanitation schedule parameters 85 and the maintenance schedule parameters 87. The schedule adjustments 102 may include adjustments to maintenance schedules, sanitation schedules, and transportation schedules. The schedule adjustments 102, may also result in updates to the at least one of the sanitation schedule parameters 85, the maintenance schedule parameter 87, and the transportation schedules 89. The updates may occur through machine learning techniques to fine tune the schedules 85, 87, 89 to specific perishable goods 34 to ensure the highest quality.

The perishable good requirements 84 may be requirements for handling and/or packaging the perishable good 34 such as, for example, government regulations, industry standards, and/or internal standards. Internal standards may be the internal standards of the producer of the perishable good 34, the transporter of the perishable good 34, the distributor of the perishable good 34, or the store selling the perishable good 34, all of which may have different perishable good requirements 84. The quality risk level 101a associated with the perishable good 34 may increase if a transport parameters 82 does not satisfy the perishable good requirements 84. In one example, the quality risk level 101a may increase due to the perishable goods 34 being kept at elevated temperatures during transportation, which is recorded as a transport parameter 82. In another example, the quality risk level 101a may increase if one perishable good previously in the transport container may contaminate a perishable good currently in the container 14.

Sanitation schedule parameters 85 are parameters regarding the sanitation requirements of the specific container 14, such as, for example, the sanitation schedule including past sanitation and planned future sanitation. The sanitation schedule parameter 85 may also include information regarding size of the container 14, shape of the container 14, material of the container 14, components within the container 14, and container components that may require specific sanitation. For instance, the transport refrigeration unit 28 may require special instructions 103. In a further example, a filter of the transport refrigeration unit 28 may need to be changed after carrying a particular type of perishable goods 34. Sanitation requirements 86 may include government regulations, industry standards and/or internal standards regarding when and how often the container 14 must be sanitized. Sanitation requirements 86 may dictate that the container 14 must be sanitized after carrying a particular perishable good 34. For example, contamination from allergens, pesticides, GMOs, and/or odors may cause contamination issues for the next perishable good 34 transported in the container 14, which may prompt sanitation. In another example, sanitation requirements 86 may dictate that two different types of perishable goods 34 may not be carried in the same container 14 due to contamination. The sanitation risk level 101b may increase if the transport parameters 82 do not satisfy the perishable good requirements 84. For instance, if a perishable good 34 is being transported not in accordance with the perishable good requirements 84, the chances that the perishable goods will spoil may increase, which subsequently also increases the sanitation risk level 101b because the spoilage might create the need to sanitize the container 14.

Maintenance schedule parameters 87 are parameters regarding the maintenance requirements of the specific container 14 and also the refrigeration unit 28 providing conditioned air to the container, such as, for example, the maintenance schedule including past maintenance and planned future maintenance. The maintenance schedule parameter 85 may also include information regarding the type of the container 14 and refrigeration unit 28; maintenance requirements for the container 14 and refrigeration unit 28; and part life on components of the container 14 and the refrigeration unit 28. For example, the maintenance schedule parameters 87 may include information such as, for example, life curves, failure rates, and a selected range of operating conditions for each component of the container 14 and the tractor 12. The selected range of conditions may define the normal operating conditions of component of the container 14 and the refrigeration unit 28. Operation outside of the selected range of conditions may increase the maintenance risk level 101c.

The meshing module 96 determines instructions 103 in response to at least one of the quality risk levels 101a, the sanitation risk levels 101b, the maintenance risk levels 101c, and the schedule adjustments 102. As seen in FIG. 1, output parameters 100 may include at least one of the risk levels 101, the schedule adjustments 102, and instructions 103. The output parameters 100 may be accessible via the user device 110 and/or sent directly to the user device 110. The meshing module 96 may be configured to transmit the output parameters 100 to the user device 110. The user device 110 may activate an alarm 120 when: the quality risk level 101a is greater than or equal to a selected quality risk level; the sanitation risk level 101b is greater than or equal to a selected sanitation risk level; and/or the maintenance risk level 101c is greater than or equal to a selected maintenance risk level. In an embodiment, the meshing module 96 may determine an overall risk level 101 in response to the quality risk level 101a, the sanitation risk level 101b, and the maintenance risk level 101c. The user device 110 may also activate an alarm 120 when the risk level 101 is above or greater than a selected risk level. The alarm 120 may be audible and/or visual.

The user device 110 may also activate the alarm 120 when instructions 103 are received. The instructions 103 may pertain to inspection of the perishable goods 34, reorganization of the perishable goods 34, sanitization of the container 14, maintenance of the container 14, and/or of the refrigeration unit 28. The instructions may indicate that the perishable goods 34 need to be inspected and provide instructions on how to examine the perishable goods 34. The instructions may also indicate that the perishable goods 34 need to be reorganized in the container 14 and provide instructions on reorganization. The instructions may indicate that sanitation of the container 14 is required and provide instructions 103. The instructions 103 may dictate, what to sanitize, how to sanitize, and how long to sanitize. The instructions 103 may also indicate that maintenance is required on a component and provide instructions 103 on how to fix the component. If the maintenance is complex, the instructions 103 may recommend a local repair facility to perform the maintenance. The schedule parameters 85, 87, 89 may subsequently be adjusted to account for any inspection, reorganization, sanitation, and/or maintenance required.

An individual may transmit user feedback 140 to the storage device 80. The user feedback 140 may include perishable parameters 82, sanitation schedule parameters 85, and maintenance schedule parameters 87. For example, once instructions 103 have been completed an individual may indicate that the instructions 103 are complete on the user device 110, which will then transmit user feedback 140 to storage device. The user feedback 140 will update at least one of the transport parameters 82, the sanitation schedule parameters 85, the maintenance schedule parameters 87, and the transportation schedules 89. The storage device 80 is configured to receive the user feedback 140 from the user device 110 and update at least one of the transport parameters 82, the sanitation schedule parameters 85, the maintenance schedule parameters 87, and the transportation schedules 89.

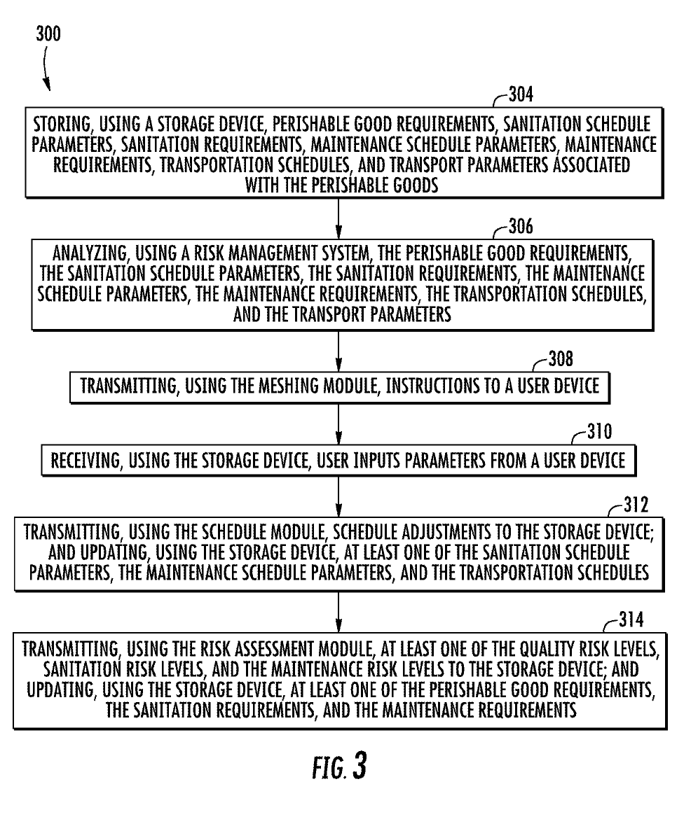

Referring now also to FIG. 3, which shows a flow diagram illustrating a method 300 for managing risk associated with the transportation of perishable goods 34, according to an embodiment of the present disclosure. At block 304, the storage device 80 stores the perishable good requirements 84, the sanitation schedule parameters 85, the sanitation requirements 86, the maintenance schedule parameters 87, the maintenance requirements 88, the transportation schedules 89 and the transport parameters 82 associated with the perishable goods 34.

At block 306, the risk management system 90 analyzes the perishable good requirements 84, the sanitation schedule parameters 85, the sanitation requirements 86, the maintenance schedule parameters 87, the maintenance requirements 88, the transportation schedules 89, and the transport parameters 82. The risk management system 90 is coupled to the storage device 80. As described above, the risk management system 90 includes: a risk assessment module 92 to determine: quality risk levels 101a in response to at least one of the transport parameters 82, the perishable good requirements 84, and the transport schedule 89; sanitation risk levels 101b in response to at least one of the transport parameters 82, the perishable good requirements 84, the sanitation schedule parameters 85 and the sanitation requirements 86; and maintenance risk levels 101c in response to at least one of the transport parameters 82, the perishable good requirements 84, the maintenance schedule parameters 87 and the maintenance requirements 88. The risk management system 90 also includes a schedule module 94 to determine schedule adjustments 102 in response to at least one of the quality risk level 101a, the sanitation risk level 101b, and the maintenance risk level 101c; and a meshing module 96 to determine instructions 103 in response to at least one of the quality risk level 101a, the sanitation risk level 101b, the maintenance risk level 101c, and the schedule adjustments 102.

Further, at block 308, the meshing module 96 may transmit the instructions 103 to the user device 110. At block 310, the storage device 80 may receive user feedback 140 from the user device 110. At block 312, the schedule module 94 transmits schedule adjustments 102 to the storage device 80; and the storage device 80 updates at least one of the sanitation schedule parameters 85, the maintenance schedule parameters 87, and the transportation schedules 89. At block 314, the risk assessment module 92 transmits at least one of the quality risk levels 101a, sanitation risk levels 101b, and the maintenance risk levels 101c to the storage device 80; and the storage device 80 updates at least one of the perishable good requirements 84, the sanitation requirements 86, and the maintenance requirements 88.

The method 300 may also include, the user device 110 activates the alarm 120 when the quality risk level 101a is greater than or equal to a selected quality risk level. The method 300 may further include, the user device 110 activates the alarm 120 when the sanitation risk level 101b is greater than or equal to a selected sanitation risk level. The method 300 may yet further include, the user device 110 activates the alarm 120 when the maintenance risk level 101c is greater than or equal to a selected maintenance risk level.

While the above description has described the flow process of FIG. 3 in a particular order, it should be appreciated that unless otherwise specifically required in the attached claims that the ordering of the steps may be varied.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for managing risk associated with the transportation of perishable goods, the system comprising:
a storage device to store perishable good requirements, sanitation schedule parameters, sanitation requirements, maintenance schedule parameters, maintenance requirements, transportation schedules, and transport parameters associated with the perishable goods; and
a risk management system coupled to the storage device, the risk management system including:
a risk assessment module to determine:
quality risk levels in response to at least one of the transport parameters, the perishable good requirements, and the transportation schedules;
sanitation risk levels in response to at least one of the transport parameters, the perishable good requirements, the sanitation schedule parameters, and the sanitation requirements; and
maintenance risk levels in response to at least one of the transport parameters, the perishable good requirements, the maintenance schedule parameters, and the maintenance requirements;
a schedule module to determine schedule adjustments in response to at least one of the quality risk level, the sanitation risk level, and the maintenance risk level; and
a meshing module to determine instructions in response to at least one of the quality risk level, the sanitation risk level, the maintenance risk level, and the schedule adjustments.

2. The system of claim 1, wherein:
the meshing module is configured to transmit the instructions to a user device.

3. The system of claim 1, wherein:
the storage device is configured to receive user input from a user device.

4. The system of claim 1, wherein:
the schedule module transmits schedule adjustments to the storage device; and
the storage device updates at least one of the sanitation schedule parameters, the maintenance schedule parameters, and the transportation schedules.

5. The system of claim 1, wherein:
the risk assessment module transmits at least one of the quality risk levels, sanitation risk levels, and the maintenance risk levels to the storage device; and
the storage device updates at least one of the perishable good requirements, the sanitation requirements, and the maintenance requirements.

6. The system of claim 1, further comprising:
at least one sensor configured to monitor the transport parameters of the perishable goods and transmit the transport parameters to the storage device.

7. The system of claim 1, further comprising:
a user device that activates an alarm when the quality risk level is greater than or equal to a selected quality risk level.

8. The system of claim 1, further comprising:
a user device that activates an alarm when the sanitation risk level is greater than or equal to a selected sanitation risk level.

9. The system of claim 1, further comprising:
a user device that activates an alarm when the maintenance risk level is greater than or equal to a selected maintenance risk level.

10. A method of managing risk associated with the transportation of perishable goods, the method comprising:
storing, using a storage device, perishable good requirements, sanitation schedule parameters, sanitation requirements, maintenance schedule parameters, maintenance requirements, transportation schedules, and transport parameters associated with the perishable goods; and
analyzing, using a risk management system, the perishable good requirements, the sanitation schedule parameters, the sanitation requirements, the maintenance schedule parameters, the maintenance requirements, the transportation schedules, and the transport parameters, the risk management system coupled to the storage device, the risk management system including:
a risk management system coupled to the storage device, the risk management system including:
a risk assessment module to determine:
quality risk levels in response to at least one of the transport parameters, the perishable good requirements, and the transportation schedules;
sanitation risk levels in response to at least one of the transport parameters, the perishable good requirements, the sanitation schedule parameters, and the sanitation requirements; and
maintenance risk levels in response to at least one of the transport parameters, the perishable good requirements, the maintenance schedule parameters, and the maintenance requirements;
a schedule module to determine schedule adjustments in response to at least one of the quality risk level, the sanitation risk level, and the maintenance risk level; and
a meshing module to determine instructions in response to at least one of the quality risk level, the sanitation risk level, the maintenance risk level, and the schedule adjustments.

11. The method of claim 10, further comprising:
transmitting, using the meshing module, instructions to a user device.

12. The method of claim 10, further comprising:
receiving, using the storage device, user inputs from a user device.

13. The method of claim 10, further comprising:
transmitting, using the schedule module, schedule adjustments to the storage device; and
updating, using the storage device, at least one of the sanitation schedule parameters, the maintenance schedule parameters, and the transportation schedules.

14. The method of claim 10, further comprising:
transmitting, using the risk assessment module, at least one of the quality risk levels, sanitation risk levels, and the maintenance risk levels to the storage device; and
updating, using the storage device, at least one of the perishable good requirements, the sanitation requirements, and the maintenance requirements.

15. The method of claim 10, further comprising:
monitoring, using at least one sensor, the transport parameters of the perishable goods; and
transmitting the transport parameters to the storage device.

16. The method of claim 10, further comprising:
activating, using a user device, an alarm when the quality risk level is greater than or equal to a selected quality risk level.

17. The method of claim 10, further comprising:
activating, using a user device, an alarm when the sanitation risk level is greater than or equal to a selected sanitation risk level.

18. The method of claim 10, further comprising:
activating, using a user device, an alarm when the maintenance risk level is greater than or equal to a selected maintenance risk level.

19. A computer program product tangibly embodied on a computer readable medium, the computer program product including instructions that, when executed by a processor, cause the processor to perform operations comprising:
storing, using a storage device, perishable good requirements, sanitation schedule parameters, sanitation requirements, maintenance schedule parameters, maintenance requirements, transportation schedules, and transport parameters associated with the perishable goods; and
analyzing, using a risk management system, the perishable good requirements, the sanitation schedule parameters, the sanitation requirements, the maintenance schedule parameters, the maintenance requirements, the transportation schedules, and the transport parameters, the risk management system coupled to the storage device, the risk management system including:
a risk management system coupled to the storage device, the risk management system including:
a risk assessment module to determine:
quality risk levels in response to at least one of the transport parameters, the perishable good requirements, and the transportation schedules;
sanitation risk levels in response to at least one of the transport parameters, the perishable good requirements, the sanitation schedule parameters, and the sanitation requirements; and
maintenance risk levels in response to at least one of the transport parameters, the perishable good requirements, the maintenance schedule parameters, and the maintenance requirements;
a schedule module to determine schedule adjustments in response to at least one of the quality risk level, the sanitation risk level, and the maintenance risk level; and
a meshing module to determine instructions in response to at least one of the quality risk level, the sanitation risk level, the maintenance risk level, and the schedule adjustments.

20. The computer program of claim 19, wherein the operations further comprise:
transmitting, using the meshing module, instructions to a user device.

21. (canceled)

22. (canceled)

23. (canceled)

24. (canceled)

25. (canceled)

26. (canceled)

27. (canceled)
